(19) United States
(12) Patent Application Publication
(10) Pub. No.: US 2010/0039339 A1
(43) Pub. Date: Feb. 18, 2010

(54) RADIO WAVE LENS ANTENNA DEVICE

(76) Inventors: Masatoshi Kuroda, Osaka-shi (JP); Koichi Kimura, Osaka-shi (JP); Tetsuo Kishimoto, Osaka-shi (JP); Masao Yokota, Minoh-shi (JP); Yoshiyuki Ishibashi, Osaka-shi (JP); Yasuhiro Kamise, Chiba-shi (JP)

Correspondence Address: MCDERMOTT WILL & EMERY LLP, 600 13TH STREET, N.W., WASHINGTON, DC, 20005-3096, US

(21) Appl. No.: 12/303,654

(22) PCT Filed: Jun. 7, 2006
(86) PCT No.: PCT/JP2006/311419

§ 371 Date: Mar. 24, 2009

(51) Int. Cl. H01Q 19/06; H01Q 19/10; H01Q 1/02

(52) U.S. Cl. 343/755; 343/704

(57) ABSTRACT

A radio wave lens antenna device including a semispherical Luneburg lens and a radio wave reflection plate. The radio wave lens antenna device prevents the signal reception sensitivity from being lowered in rain or snow. The radio wave lens antenna device includes a semispherical Luneburg lens 1, a radio wave reflection plate 2 that is larger than the diameter of the lens, an antenna element 3, and a holder 4 that holds the antenna element. The radio wave reflection plate 2 is arranged in an erected state. An ice-snow-water resistant means, which includes a first cover 5 and a second cover 6, prevents rain, snow, and ice from collecting and running off the Luneburg lens.

### RELATED APPLICATIONS

This application is the U.S. National Phase under 35 U.S.C. §371 of International Application No. PCT/JP2006/311419, filed on Jun. 7, 2006, the disclosure of which Application is incorporated by reference herein.

### FIELD OF THE INVENTION

The present invention relates to a radio wave lens antenna device that uses a Luneburg lens, and more particularly, to a radio wave lens antenna device that prevents the signal reception sensitivity from being lowered when rain falls or snow melts.

### BACKGROUND OF THE INVENTION

It is anticipated that a radio wave lens antenna using a Luneburg lens can be employed as a multibeam-applicable antenna device enabling simultaneous communication with a plurality of communication peers. Further, such radio wave lens antennas have become able to take the place of parabolic antennas as geostationary satellite antenna devices.

A Luneburg lens, which is formed by a dielectric, basically has a spherical shape. However, to miniaturize the radio wave lens, a semispherical Luneburg lens may be used in combination with a radio wave reflection plate (hereinafter, simply referred to as the reflection plate), which is larger than the diameter of the semispherical Luneburg lens, to form a radio wave lens having functions equivalent to those of a spherical Luneburg lens. Such an antenna device, which is combined with a reflection plate, may be arranged anywhere facing toward a target geostationary satellite with the reflection plate held in an erected state. For example, the antenna device may be arranged on the wall surface of a building or on the fence of a veranda. The antenna device may also be arranged on the roof of a building with the reflection plate being parallel to the ground. Thus, the antenna device has a high level of freedom of arrangement.

In an antenna device that uses a Luneburg lens, a water resistant cover covers the outer surface of the lens. For example, patent Publication 1, which is listed below, discloses a semispherical radome formed integrally with a Luneburg lens. Further, patent Publication 2, which is listed below, discloses a radome that covers an entire antenna device, which includes an antenna element. Additionally, patent Publication 3, which is listed below, discloses a semispherical cover that covers a semispherical lens.

In this manner, a radome or semispherical cover covers the lens. Thus, there is particularly no problem with durability even when wet due to rain. However, when the rain that falls during usage collects on the lens or runs off the lens surface (outer surface of a surface protection layer), the attenuation C/N amount (power ratio of signal and noise) increases and lowers the signal reception sensitivity of radio waves. Further, when snow on the lens or ice on the lens melts, water runs off the surface of the lens. This also lowers the signal reception sensitivity of radio waves.

Consideration has not been made for such a problem in the radio wave lens antenna devices of the prior art. Thus, there is a tendency for the signal reception sensitivity to become low. Further, when covering the entire antenna device with a radome, the thickness of the radome must be increased to ensure the required strength. As a result, the radome adversely affects the electrical properties, increases the size and weight, and raises costs.

Patent Publication 1: Japanese Laid-Open Patent Publication No. 50-116259 Patent Publication 2: Japanese Laid-Open Patent Publication No. 2000-183645 Patent Publication 3: Japanese Laid-Open Patent Publication No. 2002-232230 Patent Publication 4: Japanese Laid-Open Patent Publication No. 2004-282718

### SUMMARY OF THE INVENTION

Patent Publication 4, which is listed above, describes an example of a geostationary satellite antenna device that uses a Luneburg lens. This antenna device is extremely superior when used as an antenna that receives radio waves from a geostationary satellite. However, when rain falls or snow melts, the antenna device is easily affected by water that collects on or runs off the Luneburg lens. Thus, there is a tendency for the signal reception sensitivity to become lower.

It is an object of the present invention to provide a radio wave lens antenna device that improves reliability by preventing rainwater and melting snow from lowering the signal reception sensitivity.

To achieve, the above-discussed problem, in the present invention, a radio wave lens antenna device includes a semispherical Luneburg lens, a radio wave reflection plate lying along a bisectional surface of a sphere of the lens and having a size that is greater than the lens diameter, an antenna element, and a holder holding the antenna element. The radio wave lens antenna device includes an ice-snow-water resistant means which prevents rain, snow, and ice from collecting on a surface of the Luneburg lens and prevents water from running off the Luneburg lens.

A specific example of the ice-snow-water resistant means is a cover which covers part of the radio wave lens antenna device. A preferred example of the cover covers the entire Luneburg lens in a state in which the reflection plate is erected on the ground and includes an upper portion inclined at an angle that is greater than an inclination angle of an upper portion of the Luneburg lens or covers an upper portion of the Luneburg lens in a state in which the reflection plate is parallel to the ground and includes a surface inclined at an angle that is greater than an inclination angle of the surface of the Luneburg lens. The inclination angle of the cover surface and inclination angle of the lens surface are compared based on the inclination of an extension of a line connecting a point on the semispherical surface of the lens to the lens center at a point where the extension intersects the cover (the angle of inclination relative to the ground at the surface contacting each point of comparison).

Further, the cover includes a first cover, which covers the Luneburg lens in a state in which the reflection plate is erected on the ground, and a second cover, which covers an upper portion of the first cover, with the second cover having an upper portion inclined at an angle that is greater than an inclination angle of the upper portion of the first cover. In this case, it is preferred that the second cover has a lower end, which is separated from the lens and lower than the center of the lens. The inclination angle of the second cover surface and inclination angle of the first cover surface are compared based on the inclination of an extension of a line connecting a point on the first cover surface to the lens center at a point where the extension intersects the second cover (the angle of inclination relative to the ground at the surface contacting each point of comparison).

The cover includes a first semispherical cover, which covers the Luneburg lens in a state in which the reflection plate is parallel to the ground, and a second cover, which covers an upper portion of the first cover, with the second cover having an upper portion inclined at an angle that is greater than an inclination angle of the upper portion of the first cover. This can be used in an antenna device that arranges the reflection plate parallel to the ground.

The ice-snow-water resistant means includes a barrier formed on a surface of a cover covering the Luneburg lens, with the barrier being located above a line connecting the antenna lens and the lens center and extended laterally within a predetermined range. In this case, the barrier includes one of a recess, a projection, and a step. It is preferred that the barrier is located at a position that is above a portion of the cover surface facing toward the antenna element and high from the ground, and the barrier becomes gradually lower toward its two ends. It is also preferred that the barrier has a surface that undergoes a water repelling treatment.

The ice-snow-rain resistant means may include a cover arranged between the antenna element and the Luneburg lens to cover the antenna device and a surface of the Luneburg lens at a region facing toward the antenna lens.

The ice-snow-water resistant means may include a hood arranged above the Luneburg lens and extending outward from the radius of the Luneburg lens in a state in which the reflection plate is erected on the ground. The reflection plate may be inclined toward the front from a position at which it is erected orthogonally to the ground so that the inclined reflection plate also functions as the hood.

The following are examples of the ice-snow-water resistant means:

a cover that covers part of the antenna device and has a surface that has undergone one or both of a water repelling treatment and a hydrophilic treatment;

a semispherical cover that covers the Luneburg lens, with the cover including a top portion that has undergone a hydrophilic treatment and an upper portion excluding the top portion that has undergone a water-repelling treatment;

a cover that covers part of the antenna device, with the cover including a surface that has undergone a hydrophilic treatment and a water repelling treatment so that island-like hydrophobic portions are scattered in a hydrophilic portion, wherein the area of the hydrophobic portion is preferably greater than the area of the hydrophilic portions; and

the cover is formed from synthetic resin, rubber, fibers, glass or a composite of these materials. A foam of synthetic resin, rubber, and glass may be used.

The radio wave lens antenna device according to the present invention includes a cover that covers part of the antenna device to function as an ice-snow, water resistant means that prevents rain, snow, and ice from collecting on the surface of the Luneburg lens or water from running frontward to the antenna element. This prevents rain water and melted snow from collecting on the surface of the lens. A radio wave lens antenna device that includes a barrier arranged on the surface of the cover does not function to prevent the collection of rain, snow, and ice. However, rainwater or melted snow that runs along the surface of the cover is guided to the barrier or stopped by the barrier and thus does not run through a path of the radio waves that travel toward the antenna element. Accordingly, the present invention reduces the collected rainwater, snow, and ice. Further, rainwater and melted snow and ice do not run toward a position that greatly affects the signal reception sensitivity of the antenna, that is, to a position on the lens surface corresponding to the antenna element. Thus, the signal reception sensitivity is subtly lowered by running water.

### BRIEF DESCRIPTION OF THE DRAWINGS

FIG. 1 is a schematic perspective view showing a radio wave lens antenna device to which the present invention is applied;

FIG. 2 is a side view showing one example of a radio wave lens antenna device according to the present invention;

FIG. 3 is a partially cutaway side view showing another embodiment;

FIG. 4 is a partially cutaway side view showing a further embodiment;

FIG. 5 is a side view showing a further embodiment;

FIG. 6 is a partially cutaway side view showing a further embodiment;

FIG. 7 is a partially cutaway side view showing a further embodiment;

FIG. 8 is a partially cutaway side view showing a further embodiment;

FIG. 9 is a perspective view showing one example of a ribbed cover;

FIG. 10 is a perspective view showing a further embodiment;

FIG. 11 is a side view showing a further embodiment;

FIG. 12 is a partially cutaway side view showing a further embodiment;

FIG. 13 is a side view showing a further embodiment;

FIG. 14 is a side view showing a further embodiment;

FIG. 15 is a side view showing a further embodiment;

FIG. 16 is a side view showing a further embodiment;

FIGS. 17(a) to 17(e) are diagrams showing the cross-sectional shape of barriers;

FIGS. 18(a) to 18(c) are front views showing the installed state of the barriers;

FIG. 19 is a side view showing a further embodiment;

FIG. 20 is a side view showing a further embodiment;

FIG. 21 is a perspective view showing a further embodiment;

FIG. 22 is a perspective view showing a further embodiment;

FIG. 23 is a perspective view showing a further embodiment;

FIG. 24 is a side view showing a further embodiment;

FIG. 25 is a side view showing a further embodiment; and

FIG. 26 is a diagram showing a measurement system used in an experiment for checking the effects.

### DESCRIPTION OF THE REFERENCE CHARACTERS

1 Luneburg lens
2 reflection plate
3 antenna element
4 holder
5, 5A first cover
6, 12 second cover
6a skirt
6b flange
6c vertical rib
6d horizontal rib
7 cover (radome)
8 hood
9, 13 barrier
9a recess
9b projection
9c step
10 hydrophilic portion
11 hydrophobic portion
14 opening
15 third cover

### DETAILED DESCRIPTION OF THE PREFERRED EMBODIMENTS

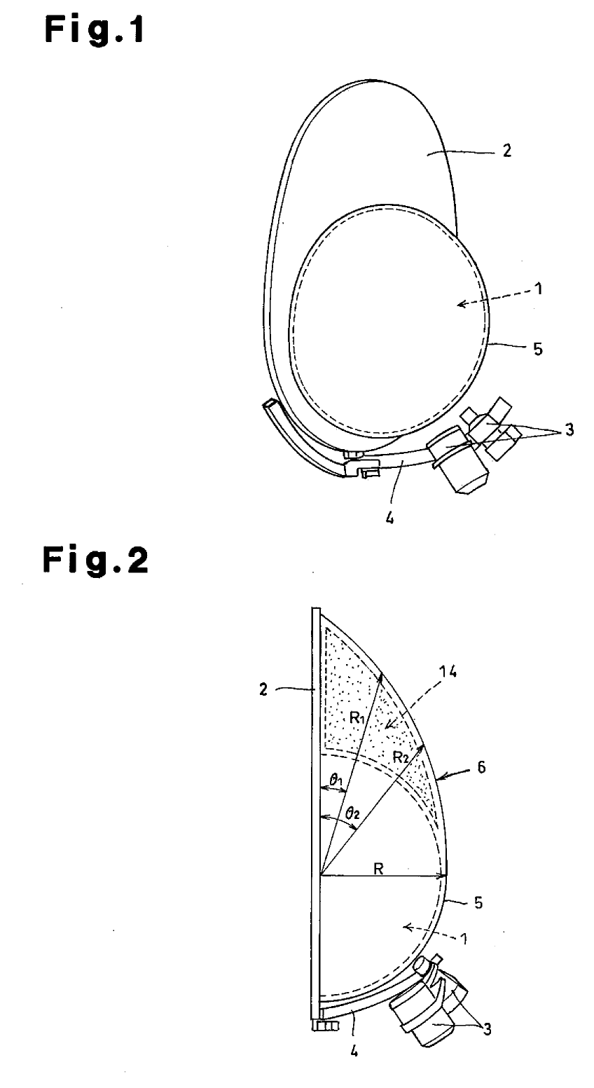

One embodiment of the present invention will now be discussed with reference to the accompanying drawings. A radio wave lens antenna device according to the present invention includes a semispherical Luneburg lens (hereinafter, simply referred to as the lens) 1, which is shown in FIG. 1, a radio wave reflection plate (hereinafter, simply referred to as the reflection plate) 2, antenna elements 3, and a holder 4. The reflection plate 2 lies along a bisectional surface of the sphere of the lens 1 and is larger than the diameter of the lens. The antenna elements 3 are arranged at a focal point of the lens. The holder 4 holds the lens elements 3.

The lens 1 is formed by a dielectric, has an internal dielectric constant that substantially varies between 2 to 1 from the center toward the outer side, and has a focal point located near the spherical surface. A semispherical first cover 5 is formed from resin, has a smooth surface, and covers the periphery of the lens 1 to protect the lens 1.

The reflection plate 2 has longitudinal and lateral dimensions that are greater than the diameter of the lens 1. The radio wave lens antenna of the present invention may be used in states in which the reflection plate 2 is substantially orthogonal to the ground, the reflection plate 2 is forwardly inclined to the ground, and the reflection plate 2 is substantially parallel to the ground. In any of these cases, the antenna elements 3 are arranged at a position where radio waves from a target geostationary satellite are converged (focal portion).

A low-noise block converter (LNB) is used for each of the antenna elements 3. The antenna elements 3 may be a horn antenna or a cylindrical antenna having a front portion from which a dielectric is suspended. Further, an arm enabling adjustment of the element positions is used as the holder 4.

The antenna device of FIG. 1 includes an ice-snow-water resistant means, which is the feature of the present invention. Examples of the ice-snow-water resistant means are shown in FIGS. 2 to 25. In the radio wave lens antenna device shown in FIG. 2, the reflection plate 2 is arranged substantially orthogonal to the ground. The first cover 5 covers the entire lens 1. The upper portion of the cover is inclined at an angle that is greater than the inclination angle at an upper portion of the lens 1. The first cover 5 functions as the ice-snow-water resistant means.

An opening 14 between the first cover 5 and the lens 1 may be hollow. However, it is preferable that the opening 14 be filled with an olefin resin foam having a high foaming ratio and a dielectric constant that is as close as possible to 1.

It is preferable that the inclination angle of the surface of the first cover 5 be greater than the inclination angle of the lens. In FIG. 2, when R represents the lens diameter, R₁ represents the distance from the lens center to the first cover 5 at a position where the angle from the reflection plate 2 is θ₁, and R₂ represents the distance from the lens center to the first cover 5 at a position where the angle from the reflection plate 2 is θ₂, it is preferable that the first cover 5 be shaped so as to satisfy the condition of R₁>R₂>R when θ₂>θ₁ and θ2≦πR/2 are fulfilled.

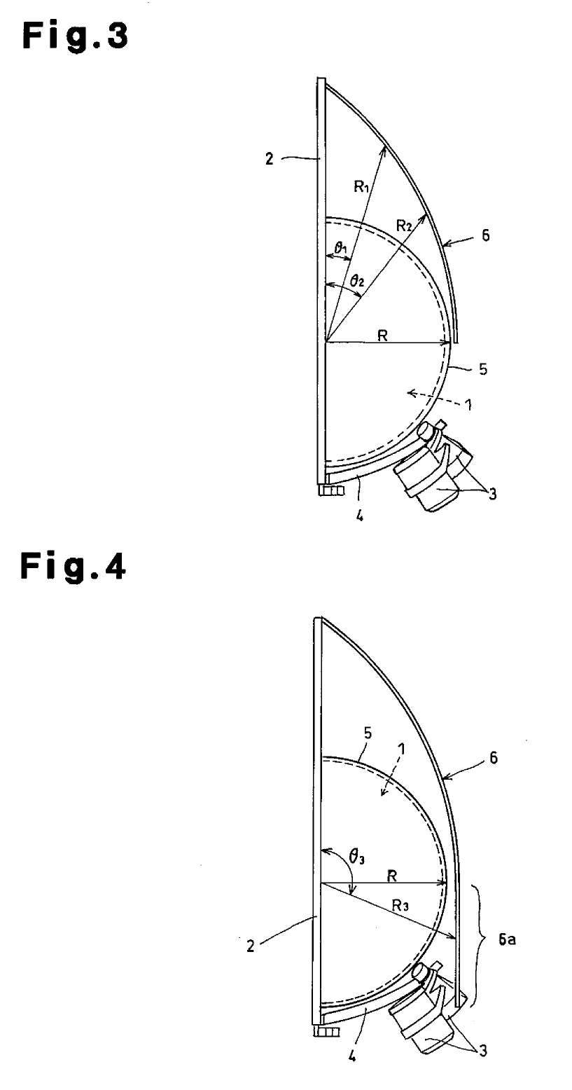

In the radio wave lens antenna device shown in FIG. 3, the reflection plate 2 is arranged substantially orthogonal to the ground. An aspheric second cover 6 covers part of the antenna device. The surface of the second cover 6 is inclined at an angle that is greater than the inclination angle of the surface of the first cover 5. The second cover 6 functions as the ice-snow-water resistant means.

It is preferable that the inclination angle of the outer surface of the second cover 6 be greater than the inclination angle of an upper portion of the lens. In FIG. 3, when R represents the lens diameter, R₁ represents the distance from the lens center to the second cover 6 at a position where the angle from the reflection plate 2 is θ₁, and R₂ represents the distance from the lens center to the second cover 6 at a position where the angle from the reflection plate 2 is θ₂, it is preferable that the second cover 6 be shaped so as to satisfy the condition of R₁>R₂>R when θ₂>θ₁ and θ₂≦πR/2 are fulfilled.

As shown in FIG. 4, the lower end of the second cover 6 may be extended to a position separated from the lens 1 and located lower than the lens center (i.e., a skirt 6a may be formed). This prevents rainwater and melting snow from being collected. In addition, water droplets subtly reach the lower portion of the first cover 5. Thus, water does not run along the path of radio waves directed toward the antenna elements 3, and the radio waves travel without any interference.

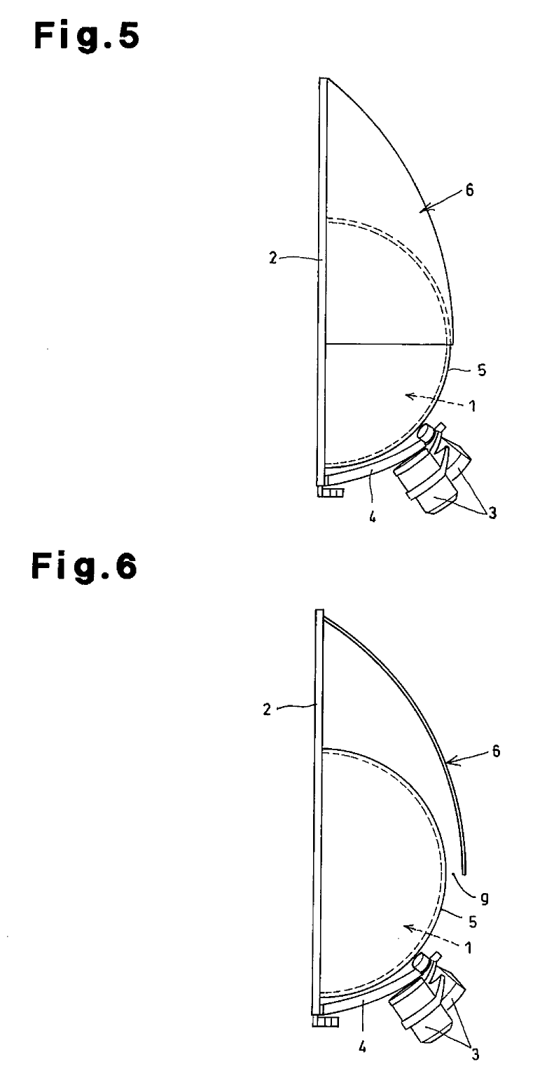

Further, in the antenna device shown in FIG. 3, the second cover 6 may have a lower end that comes into contact with the surface of the lens 1 as shown in FIG. 5 or a lower end that is separated from the lens so as to form a gap g as shown in FIG. 6. When in contact with the lens, the wind resistance is increased. When separated from the lens, water that runs along the second cover 6 does not reach the surface of the lens 1 (first cover 5).

It is preferred that the first cover 5 have a thickness of 2 mm or less and more preferred that the thickness be 1 mm or less so as to prevent the electrical properties of the antenna from being adversely affected.

It is preferred that the gap between the first cover 5 and the lens 1 be small to decrease electrical losses and ensure the required strength. The first cover 5 and lens 1 may be adhered or fused to each other.

The surface of the first cover 5 may be coated.

The second cover 6 is formed from a material that transmits radio waves, such as synthetic resin, rubber, fiber, glass or a composite of these materials (e.g., a laminated body). It is preferred that a polyolefin resin, the type of which is not particularly designated, having a low electric tan δ be used.

The second cover 6 does not have to be a molded product. The second cover 6 may be a thin sheet-like cover or a thin fabric that does not have a shape retaining property. Such a sheet-like cover or fabric is flapped by winds. This easily disperses water drops collected on the surface of the cover. Thus, the cover has a superior water dispersing property. When using a transparent resin such as an acrylic resin or polycarbonate resin, the size of the cover may be reduced.

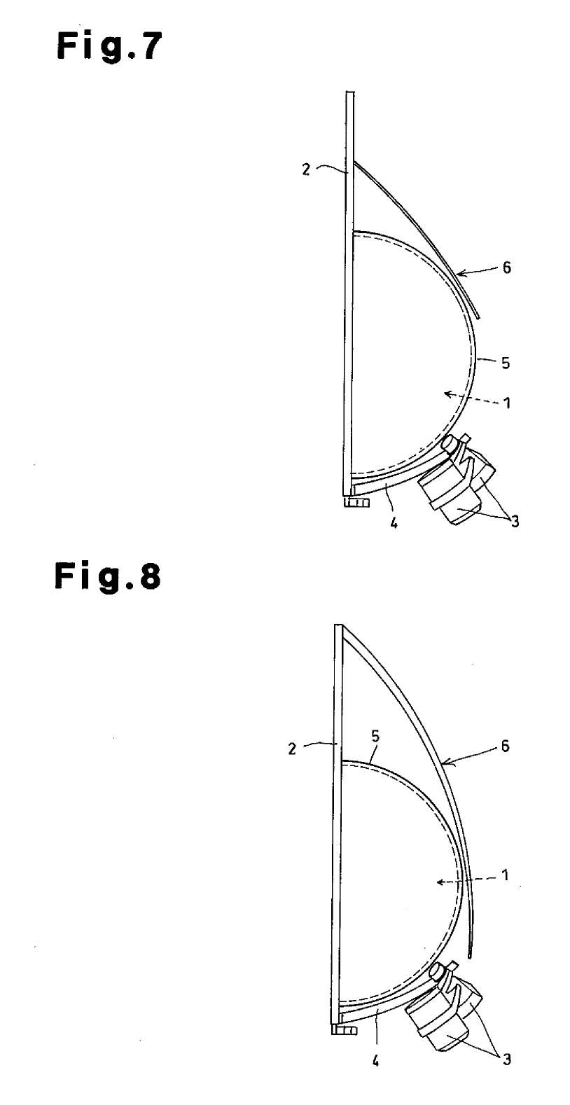

As shown in FIG. 7, the second cover 6 may have an upper end, which is lower than the upper end of the reflection plate 2.

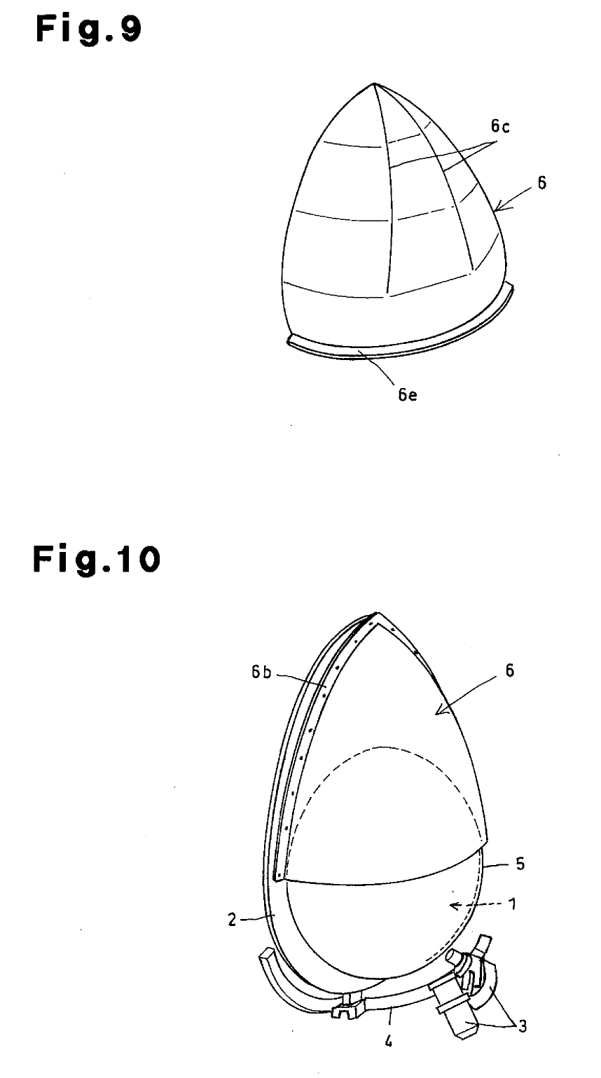

In the same manner as the first cover 5, it is preferred that the second cover 6 have a thickness of 2 mm or less and more preferred that the thickness be 1 mm or less so as to prevent the electrical properties of the antenna from being adversely affected. Further, the thickness does not have to be uniform and may vary as shown in FIG. 8. By varying the thickness, the electrical properties of the antenna device are prevented from being adversely affected by the thickness, while ensuring the required strength. As shown in FIG. 9, vertical ribs 6c and horizontal ribs 6d may be added to decrease the thickness of the second cover 6 and reduce the material costs and weight of the cover. The vertical ribs 6d shown in the drawing are formed by bent sections. However, the ribs may be molded.

The rim of the second cover 6 that comes into contact with the reflection plate 2 may be sealed to prevent the entry of rainwater. A double-sided adhesive tape may be used to seal the rim. Further, the rim may be fastened to the reflection plate 2 by screws or bolts to prevent displacement and increase reliability. An attachment flange 6b such as that shown in FIG. 10 may be used so that the second cover 6 is attached to the reflection plate 2 with screws or bolts in a reliable manner. Resin bolts may be used so that the second cover 6 can be freely detached from the reflection plate 2.

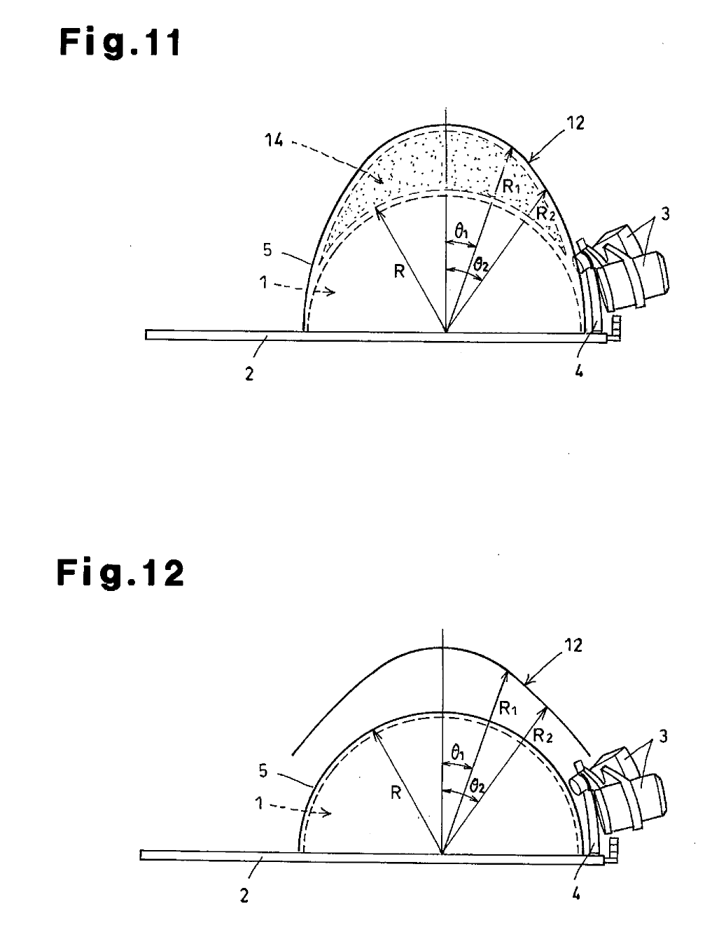

FIG. 11 shows a radio wave lens antenna device of which the reflection plate 2 is arranged substantially parallel to the ground. In this device, the first cover 5 covers the entire lens 1 and has an upper portion inclined at an angle that is greater than the inclination angle of the upper portion of the lens 1. The first cover 5 functions as the ice-snow-water resistant means.

An opening 14 between the first cover 5 and the lens 1 may be hollow. However, it is preferable that the opening 14 be filled with an olefin resin foam having a high foaming ratio and a dielectric constant that is as close as possible to 1.

It is preferable that the inclination angle of the surface of the first cover 5 be greater than the inclination angle of the lens. In FIG. 2, when R represents the lens diameter, R₁ represents the distance from the lens center to the first cover 5 at a position where the angle from the reflection plate 2 is ƒ₁, and R₂ represents the distance from the lens center to the first cover 5 at a position where the angle from the reflection plate 2 is θ₂, it is preferable that the first cover 5 be shaped so as to satisfy the condition of R₁>R₂>R when θ₂>θ₁ and θ₂≦πR/2 are fulfilled. In such a case, the first cover 5 would have a superior water dispersing property.

The radio wave lens antenna device shown in FIG. 12 is arranged on the ground in a state in which the reflection plate 2 is substantially horizontal. An aspheric second cover 12 covers part of the antenna device. The surface of the second cover 12 is inclined at an angle that is greater than the inclination angle of the surface of the first cover 5. The second cover 12 functions as the ice-snow-water resistant means.

It is preferable that the inclination angle of the outer surface of the second cover 12 be greater than the inclination angle of an upper portion of the lens. In FIG. 12, when R represents the lens diameter, R₁ represents the distance from the lens center to the second cover 12 at a position where the angle from the reflection plate 2 is θ₁, and R₂ represents the distance from the lens center to the second cover 12 at a position where the angle from the reflection plate 2 is θ₂, it is preferable that the second cover 12 be shaped so as to satisfy the condition of R₁>R₂>R when θ₂>θ₁ and θ₂≦πR/2 are fulfilled.

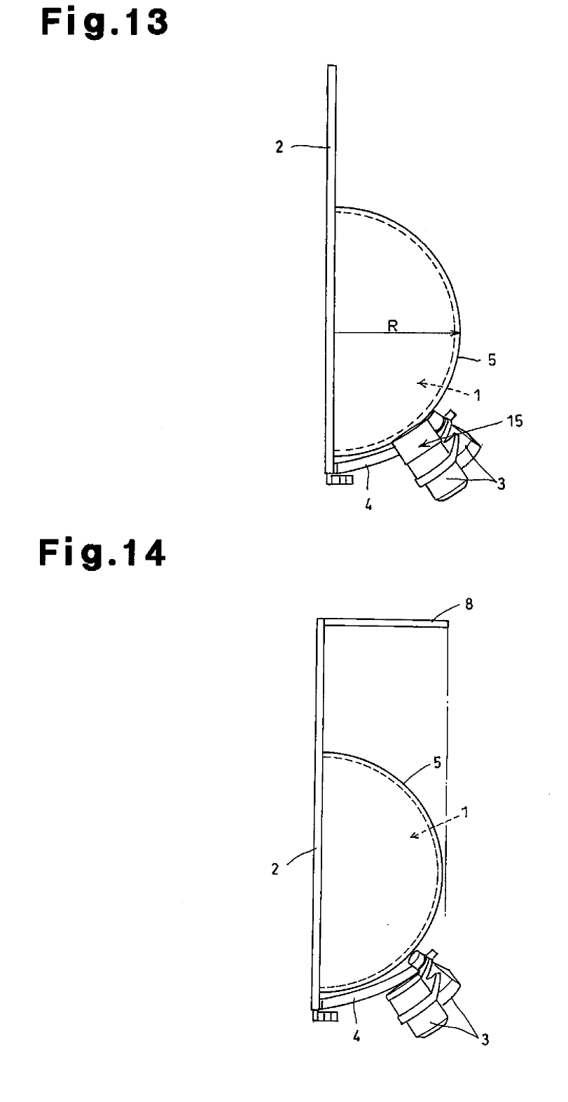

In the radio wave lens antenna device shown in FIG. 13, the reflection plate 2 is arranged substantially orthogonal to the ground. A third cover 15 is arranged between the antenna elements 3 and a portion of the lens surface (first cover 5) facing toward the antenna elements 3. The third cover 15 functions as the ice-snow-water resistant means. The third cover 15 is only required to be located above lines that connect the antenna elements 3 to the center of the lens 1. Although the shape is not particularly specified, it is preferable that the third cover 15 be tubular. The third cover 15 may also be employed in an antenna device in which the reflection plate 2 is arranged substantially parallel to the ground. Further, the third cover 15 may be used in combination with the first cover 5 and the second cover 6 or 12, which have been described above, to obtain synergistic effects.

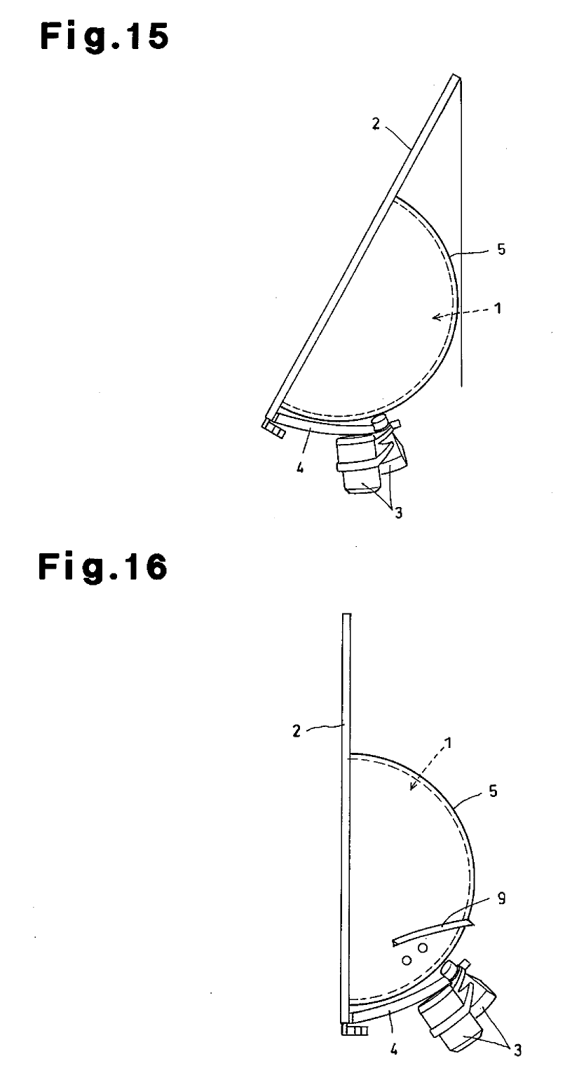

FIGS. 14 and 15 each show a hood that functions as an ice-snow-water resistant means. These radio wave lens antenna devices include the elements illustrated in FIG. 1. In the antenna device of FIG. 14, in a state in which the reflection plate 2 is arranged substantially orthogonal to the ground, a hood 8 extends above the lens 1. The hood 8 is extended from the reflection plate 2 for a distance that is greater than the lens radius R so as to completely hide the lens 1 when viewed from above.

In the radio antenna device of FIG. 15, the reflection plate 2 is inclined toward the front so that the upper end of the reflection plate 2 is located frontward from the lens 1. Thus, the reflection plate 2 functions as a hood to protect the lens 1 from rain and snow. This structure is meritorious in that it obtains the advantages of the invention without the need for special components.

FIGS. 16 to 18 each show a radio wave lens antenna device including a semispherical cover 5A (which may be identical to the afore-mentioned first cover). A barrier 9 is arranged on the surface of the cover 5A to function as an ice-snow-water resistant means. The radio wave lens antenna device includes the semispherical cover 5A so as to cover and protect the lens 1. The barrier 9 is arranged on the outer surface of the semispherical cover 5. The barrier 9 is located above lines connecting the antenna elements 3 to the center of the lens 1 and extends laterally over a predetermined length.

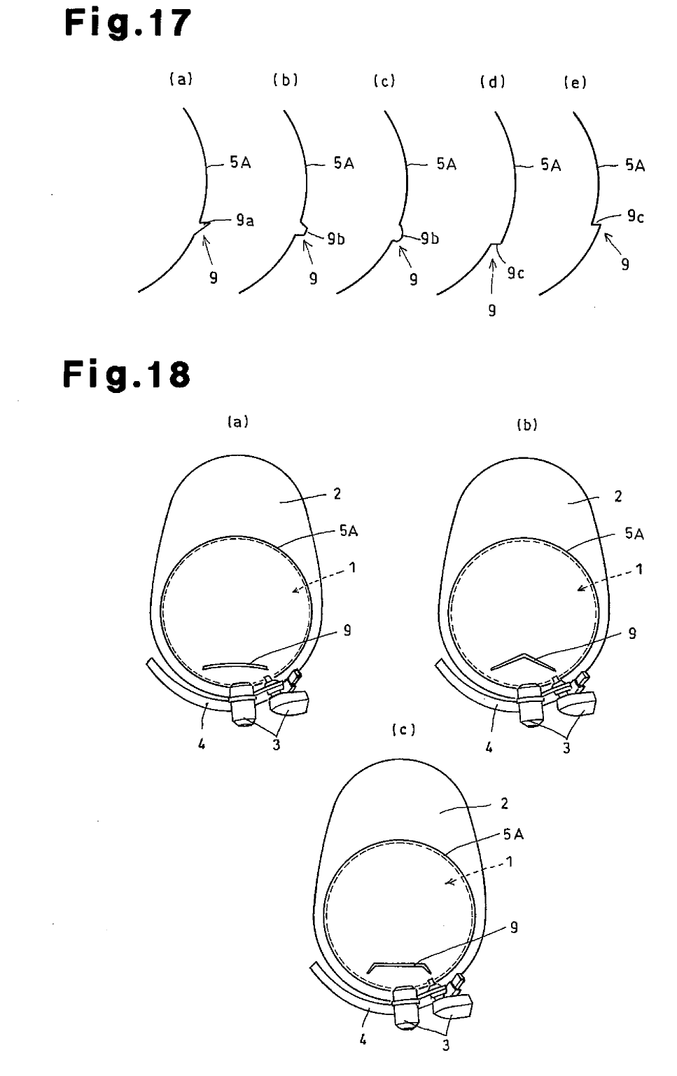

The portion of the cover surface corresponding to the antenna elements 3 is in a region in which radio waves travel toward the antenna elements. Thus, by preventing water from running through this region, the attenuation of the radio waves that would be caused by such water can be decreased. To achieve this object, the barrier 9 is arranged on the outer surface of the semispherical cover 5A to block the path of running water. The barrier 9 may include a recess 9a as shown in FIG. 17(a), a projection 9b as shown in FIGS. 17(b) and 17(c), or a step 9c formed in the outer surface of the semispherical cover 5A as shown in FIGS. 17(d) and 17(e). Each barrier 9 has a predetermined width.

As shown in FIG. 18, it is preferable that the portion of the barrier 9 facing toward the antenna elements 3 is located at a high position from the ground and that the barrier 9 gradually becomes lower toward the lateral ends. This effectively guides water to a region that does not affect the reception of radio waves.

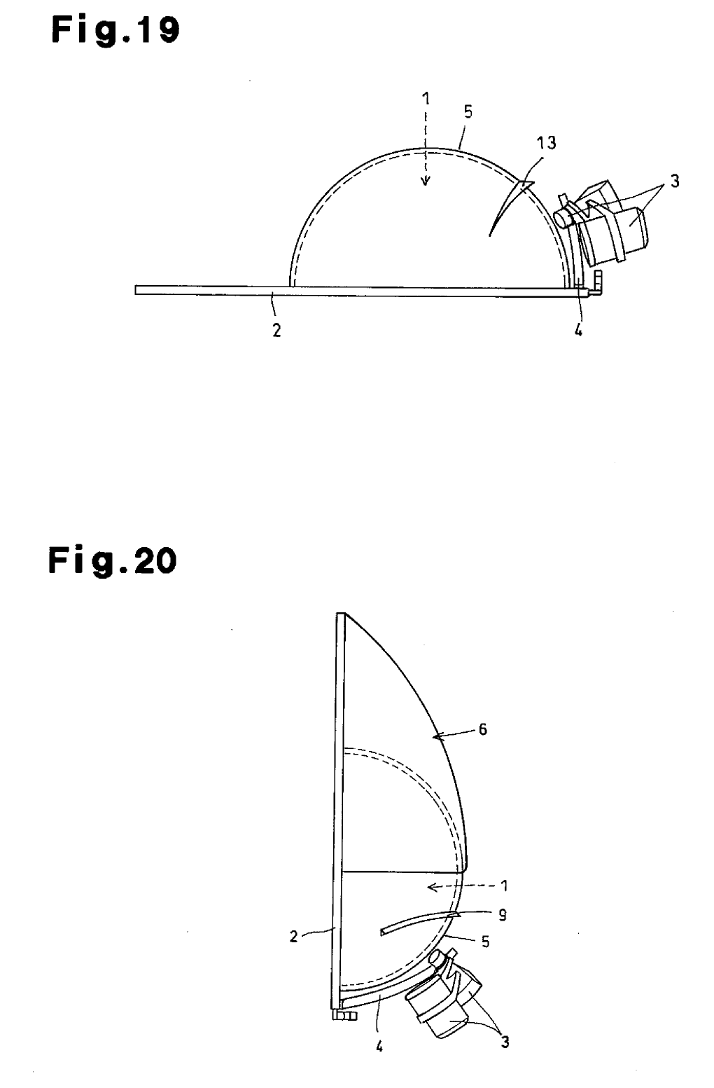

In the radio wave lens antenna device of FIG. 19, the barrier 13 is arranged on the outer surface of the semispherical first cover 5 to prevent water from running toward a portion of the cover that corresponds to the antenna elements 3. In this manner, the barrier is effective not only when the reflection plate 2 is arranged orthogonal to the ground but also when the reflection plate 2 is arranged parallel to the ground.

FIG. 20 shows a radio wave lens antenna device that includes the second cover 6 of FIG. 3 and the barrier 9 of FIG. 16. This radio wave lens antenna device synergistically obtains the effect of the second cover 6, which prevents rain water and melted snow from collecting, and the effect of the barrier 9, which prevents water from running to a portion facing toward the antenna elements 3. Thus, this structure is effective for drastically decreasing the attenuation of radio waves when rain falls and snow melts.

A cover surface that is water-repellant would be one effective example of a snow-ice-water resistant means that prevents the collection of rain water and melted snow. When the first cover 5 or the second cover 6 (or 12) undergoes a water repelling treatment, water comes into contact with the cover at a large angle. This repels the water so that the water does not collect on the cover surface. It is especially preferable that a water repelling treatment be carried out on the second cover 6 (or 12), which has a large inclination, since such a structure would be effective for preventing the collection of water.

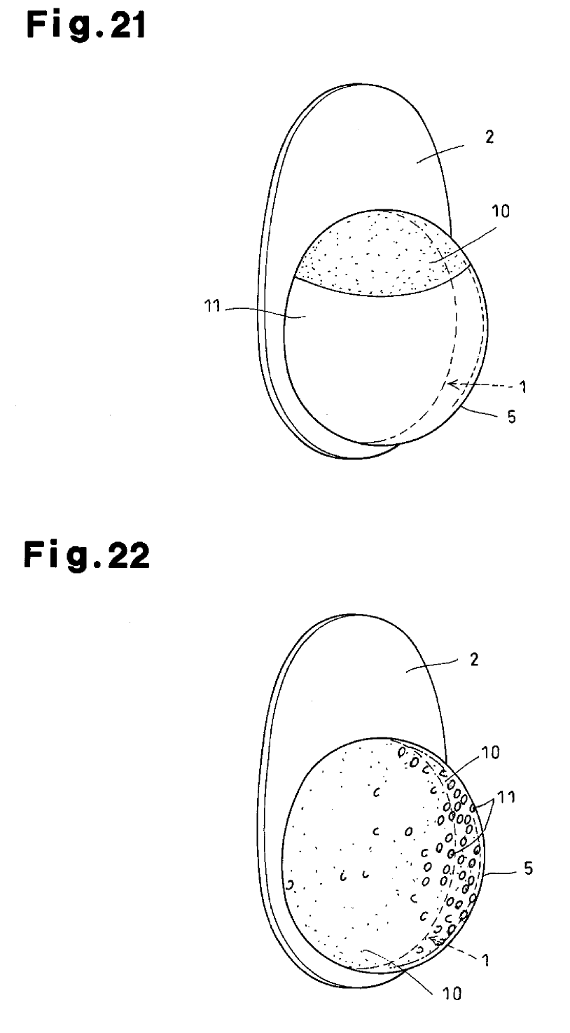

In FIG. 21, a hydrophilic treatment is carried out on the top of the first cover 5 to define a hydrophilic portion 10, and a water repelling treatment is carried out on the upper sloped surface of the first cover 5 excluding the top to define a hydrophobic portion 11. When the surface that is closer to the ground undergoes a water repelling treatment, repelled water does not run and forms water droplets that collect on the cover. This is counterproductive. Thus, a hydrophilic treatment is carried out on only the top portion to prevent the collection of water.

FIG. 22 shows an example in which a coating layer, or a so-called “sea-island structure”, is formed on the surface of the first cover 5 by a hydrophilic coating that includes small hydrophobic coatings. In such a structure, water is repelled by hydrophobic portions 11 (island portions), which are formed by the hydrophobic coatings, and runs along hydrophilic portions 10 (sea portions). This prevents the collection of rainwater and melted ice and snow. It is preferred that the hydrophobic portions 11 be small and have a diameter of 1 to 5 mm. Further, since the hydrophilic portions 10 temporarily form a water film, it is preferred that the area ratio of the hydrophobic portions 11 and hydrophilic portions 10 be such that the area of the hydrophobic portions 11 be greater than the area of the hydrophilic portions 10.

A water repelling treatment may be performed on the barriers 9 shown in FIGS. 17 and 18 at portions where the water dispersing property should be especially increased to improve the hydrophobic property.

A water repelling treatment and hydrophilic treatment are normally carried out by the application of a water repellant or hydrophilic coating. However, the present invention is not limited in such a manner and other surface modification treatments may be performed.

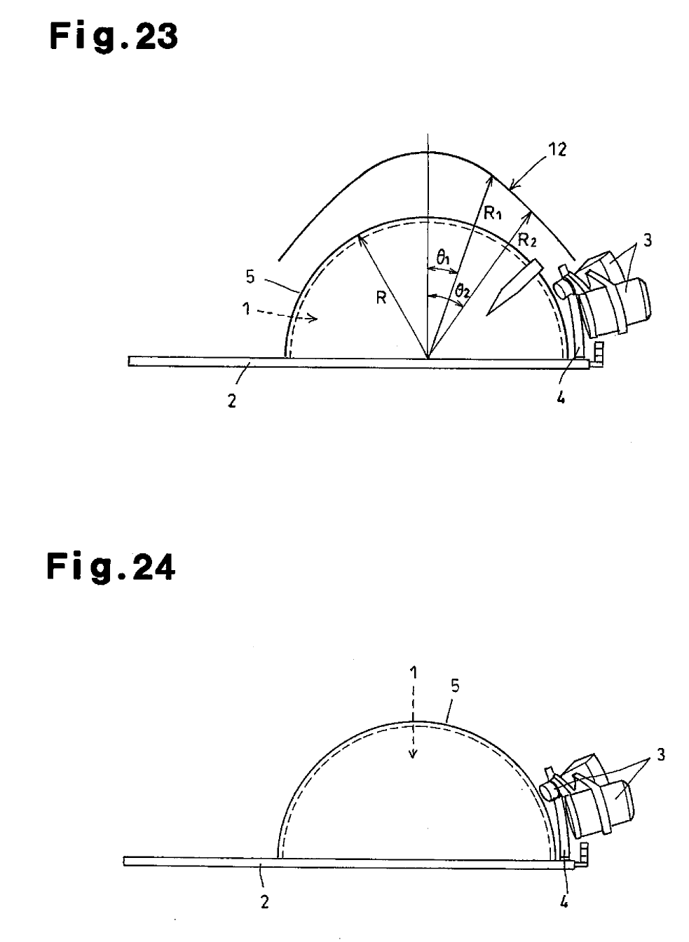

The above described ice-snow-water resistance means may be used in combination, for example, as shown in FIGS. 23 to 25.

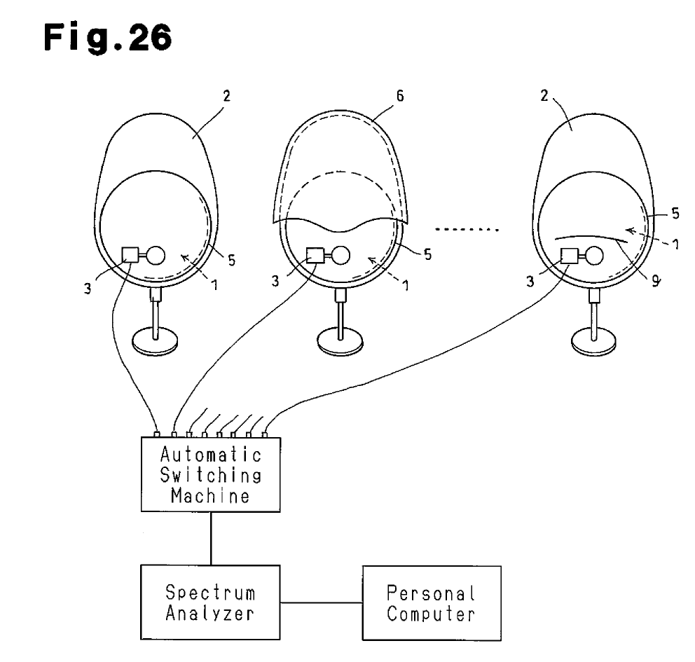

An experiment that was conducted to check the effects of the present invention will now be described. In the experiment, radio wave lens antenna devices (examples and comparative examples) of the specifications shown in table 1 were prepared. The measurement system shown in FIG. 26 was used to measure the signal reception sensitivity (C/N) of the antenna devices every ten minutes in rain or snow. Normally, images cannot be generated on a TV display when C/N<6 is satisfied. Thus, the time in which C/N≧6 was satisfied was checked to obtain the ratio relative to the time during which C/N<6 was satisfied. The results are shown in table 1. As apparent from table 1, in the examples to which the present invention was applied, the time during which radio wave disturbance occurred was shorter (the time during which images were generate was longer) than the comparative examples. Accordingly, it is apparent that the ice-snow-water prevention means is effective for preventing rain and snow from lowering the signal reception sensitivity.

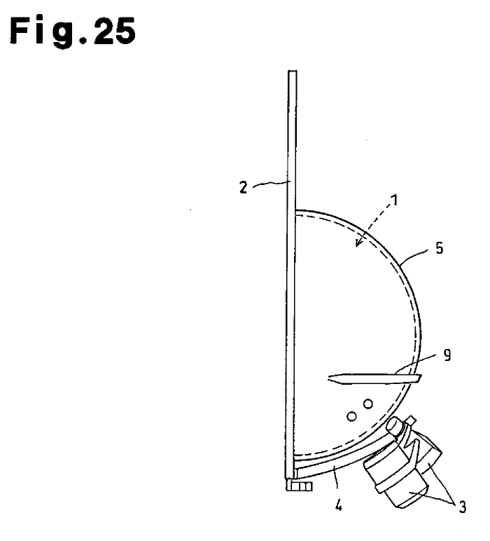

TABLE 1

| | Antenna Shape | | | | |
|---|---|---|---|---|---|
| | | | | | Element |
| | Outer Appearance | Configuration | 1st Cover | 2nd Cover | Cover |
| Example 1 | FIG. 2 | Vertical | Nut-Shaped | — | — |
| Comparative | FIG. 1 | Vertical | Semispherical | — | — |
| Example 1 | | | | | |
| Example 2 | FIG. 3 | Vertical | Semispherical | Length: | — |
| | | | | Lens | |
| | | | | Center | |
| Example 3 | FIG. 4 | Vertical | Semispherical | Length: | — |
| | | | | Downward | |
| | | | | from Lens | |
| | | | | Center | |
| Example 4 | FIG. 20 | Vertical | Semispherical | Length: | — |
| | | | | Lens | |
| | | | | Center | |
| Example 5 | Water Repelling | Vertical | Semispherical | Length: | — |
| | Treatment on Barrier 9 of | | | Downward | |
| | FIG. 4 | | | from Lens | |
| | | | | Center | |
| Example 6 | FIG. 11 | Horizontal | Long-Hat-Shaped | — | — |
| Example 7 | FIG. 23 | Horizontal | Semispherical | Long-Hat- | — |
| | | | | Shaped | |
| Comparative | FIG. 24 | Horizontal | Semispherical | — | — |
| Example 2 | | | | | |
| Example 8 | FIG. 25 | Vertical | Semispherical | — | — |
| Example 9 | FIG. 16, Shape of Barrier | Vertical | Semispherical | — | — |
| | 9 as in FIG. 17b | | | | |
| Example 10 | FIG. 16, Shape of Barrier | Vertical | Semispherical | — | — |
| | 9 as in FIG. 17e | | | | |
| Example 11 | FIG. 16, Shape of Barrier | Vertical | Semispherical | — | — |
| | 9 as in FIG. 17d | | | | |
| Example 12 | FIG. 13 | Vertical | Semispherical | — | Element |
| | | | | | Cover |
| Example 13 | FIG. 16, Shape of Barrier | Vertical | Semispherical | — | — |
| | 9 as in FIG. 17b, Water | | | | |
| | Repelling Treatment on | | | | |
| | Barrier 9 | | | | |
| Example 14 | FIG. 15 | Vertical | Semispherical | — | — |
| Example 15 | FIG. 14 | Vertical | Semispherical | — | — |
| Example 16 | FIG. 1, Water Repelling | Vertical | Semispherical | — | — |
| | Treatment on Entire First | | | | |
| | Cover 5 | | | | |
| Example 17 | FIG. 21 | Vertical | Semispherical | — | — |
| Example 18 | FIG. 22 | Vertical | Semispherical | — | — |
| Example 19 | FIG. 2 | Vertical | Nut-Shaped | — | — |
| Comparative | FIG. 1 | Vertical | Semispherical | — | — |
| Example 3 | | | | | |
| Example 20 | FIG. 4 | Vertical | Semispherical | Length: | — |
| | | | | Downward | |
| | | | | from Lens | |
| | | | | Center | |
| Example 21 | FIG. 16, Shape of Barrier | Vertical | Semispherical | — | — |
| | 9 as in FIG. 17b | | | | |
| Example 22 | FIG. 13 | Vertical | Semispherical | — | Element |
| | | | | | Cover |
| Example 23 | FIG. 15 | Vertical | Semispherical | — | — |
| Example 24 | FIG. 1, Water Repelling | Vertical | Semispherical | — | — |
| | Treatment on Entire First | | | | |
| | Cover 5 | | | | |

| | | | | Signal Reception Property | | | |
|---|---|---|---|---|---|---|---|
| | | | | | | | Ratio of |
| | | | | Total | | Image- | Image- |
| | Antenna Shape | | | Evaluation | Rain/ | Generated | Generated |
| | Step | Hood | — | Time (H) | Snow | Time (H) | Time (%) |
| Example 1 | — | — | — | 2304 | Rain | 2286 | 99.2 |
| Comparative | — | — | — | 2304 | Rain | 2212 | 96.0 |
| Example 1 | | | | | | | |
| Example 2 | — | — | — | 2304 | Rain | 2288 | 99.3 |
| Example 3 | — | — | — | 2304 | Rain | 2297 | 99.7 |
| Example 4 | Projection | — | — | 2304 | Rain | 2299 | 99.8 |
| Example 5 | — | — | 2nd Cover | 2304 | Rain | 2302 | 99.9 |
| | | | Water | | | | |
| | | | Repelling | | | | |
| | | | Treatment | | | | |
| Example 6 | — | — | — | 2304 | Rain | 2279 | 98.9 |
| Example 7 | Projection | — | — | 2304 | Rain | 2286 | 99.2 |
| Comparative | — | — | — | 2304 | Rain | 2221 | 92.0 |
| Example 2 | | | | | | | |
| Example 8 | Projection | — | — | 2304 | Rain | 2261 | 98.1 |
| | Lateral Line | | | | | | |
| Example 9 | Projection | — | — | 2304 | Rain | 2274 | 98.7 |
| Example 10 | L | — | — | 2304 | Rain | 2272 | 98.6 |
| Example 11 | Reversed L | — | — | 2304 | Rain | 2275 | 98.7 |
| Example 12 | — | — | — | 2304 | Rain | 2276 | 98.8 |
| Example 13 | Projection | — | Barrier 9 | 2304 | Rain | 2283 | 99.1 |
| | | | Water | | | | |
| | | | Repelling | | | | |
| | | | Treatment | | | | |
| Example 14 | — | Inclined | — | 2304 | Rain | 2280 | 99.0 |
| | | Reflection | | | | | |
| | | Plate | | | | | |
| Example 15 | — | Hood | — | 2304 | Rain | 2281 | 99.0 |
| Example 16 | — | — | Entirely | 2304 | Rain | 2280 | 99.0 |
| | | | Water | | | | |
| | | | Repellant | | | | |
| Example 17 | — | — | Top | 2304 | Rain | 2288 | 99.3 |
| | | | Hydrophilic, | | | | |
| | | | Remainder | | | | |
| | | | Water | | | | |
| | | | Repellant | | | | |
| Example 18 | — | — | Sea-Island | 2304 | Rain | 2290 | 99.4 |
| Example 19 | — | — | — | 3648 | Snow | 3613 | 99.0 |
| Comparative | — | — | — | 3648 | Snow | 3457 | 95.0 |
| Example 3 | | | | | | | |
| Example 20 | — | — | — | 3648 | Snow | 3640 | 99.8 |
| Example 21 | Projection | — | — | 3648 | Snow | 3574 | 98.0 |
| Example 22 | — | — | — | 3648 | Snow | 3583 | 98.2 |
| Example 23 | — | Inclined | — | 3648 | Snow | 3627 | 99.4 |
| | | Reflection | | | | | |
| | | Plate | | | | | |
| Example 24 | — | — | Entirely | 3648 | Snow | 3603 | 98.8 |
| | | | Water | | | | |
| | | | Repellant | | | | |

1. A radio wave lens antenna device comprising a semispherical Luneburg lens, a radio wave reflection plate lying along a bisectional surface of a sphere of the lens and having a size that is greater than the lens diameter, an antenna element, a holder holding the antenna element, and
an ice-snow-water resistant means which prevents rain, snow, and ice from collecting on a surface of the Luneburg lens and prevents water from running off the Luneburg lens.

2. The radio wave lens antenna device according to claim 1, wherein the ice-snow-water resistant means includes a cover which covers part of the radio wave lens antenna device.

3. The radio wave lens antenna device according to claim 2, wherein the cover covers the entire Luneburg lens in a state in which the reflection plate is erected on the ground, and the cover includes an upper portion inclined at an angle that is greater than an inclination angle of an upper portion of the Luneburg lens.

4. The radio wave lens antenna device according to claim 2, wherein the cover includes a first semispherical cover, which covers the Luneburg lens in a state in which the reflection plate is erected on the ground, and a second cover, which covers an upper portion of the first cover, with the second cover having an upper portion inclined at an angle that is greater than an inclination angle of the upper portion of the first cover.

5. The radio wave lens antenna device according to claim 4, wherein the second cover has a lower end, which is separated from the lens and lower than the center of the lens.

6. The radio wave lens antenna device according to claim 2, wherein the cover covers an upper portion of the Luneburg lens in a state in which the reflection plate is parallel to the ground, and the cover includes a surface inclined at an angle that is greater than an inclination angle of the surface of the Luneburg lens.

7. The radio wave lens antenna device according to claim 2, wherein the cover includes a first semispherical cover, which covers the Luneburg lens in a state in which the reflection plate is parallel to the ground, and a second cover, which covers an upper portion of the first cover, with the second cover having an upper portion inclined at an angle that is greater than an inclination angle of the upper portion of the first cover.

8. The radio wave lens antenna device according to claim 1, wherein the ice-snow-water resistant means includes a barrier formed on a surface of a cover covering the Luneburg lens, with the barrier being located above a line connecting the antenna lens and the lens center and extended laterally within a predetermined range.

9. The radio wave lens antenna device according to claim 8, wherein the barrier includes one of a recess, a projection, and a step.

10. The radio wave lens antenna device according to claim 8, wherein the barrier is located at a position that is above a portion of the cover surface facing toward the antenna element and high from the ground, and the barrier becomes gradually lower toward its two ends.

11. The radio wave lens antenna device according to claim 8, wherein the barrier has a surface that has undergone a water repelling treatment.

12. The radio wave lens antenna device according to claim 1, wherein the ice-snow-rain resistant means includes a cover arranged between the antenna element and the Luneburg lens to cover the antenna element and a surface of the Luneburg lens at a region facing toward the antenna element.

13. The radio wave lens antenna device according to claim 1, wherein the ice-snow-water resistant means includes a hood arranged above the Luneburg lens and extending outward from the radius of the Luneburg lens in a state in which the reflection plate is erected on the ground.

14. The radio wave lens antenna device according to claim 13, wherein the reflection plate is inclined toward the front from a position at which it is erected orthogonally to the ground so that the inclined reflection plate also functions as the hood.

15. The radio wave lens antenna device according to claim 1, wherein the ice-snow-water resistant means includes a cover that covers part of the antenna device and has a surface that has undergone one or both of a water repelling treatment and a hydrophilic treatment.

16. The radio wave lens antenna device according to claim 15, wherein the ice-snow-water resistant means includes a semispherical cover that covers the Luneburg lens, with the cover including a top portion that has undergone a hydrophilic treatment and an upper portion excluding the top portion that has undergone a water-repelling treatment.

17. The radio wave lens antenna device according to claim 15, wherein the ice-snow-water resistant means includes a cover that covers part of the antenna device, with the cover including a surface that has undergone a hydrophilic treatment and a water repelling treatment so that island-like hydrophobic portions are scattered in a hydrophilic portion.

18. The radio wave lens antenna device according to claim 17, wherein the area of the hydrophobic portion is greater than the area of the hydrophilic portions.

19. The radio wave lens antenna device according to claim 2, wherein the cover is formed from synthetic resin, rubber, fibers, glass or a composite of these materials.
